(19) United States
(12) Patent Application Publication
(10) Pub. No.: US 2026/0335908 A1
(43) Pub. Date: Oct. 29, 2026

(54) NOZZLE ASSEMBLY FOR PRESSURE RELIEF VALVE

(71) Applicants: DENSO International America, Inc., Southfield, MI (US); DENSO CORPORATION, Kariya (JP)

(72) Inventors: Kinich Quitze SAUCEDO GROVAS, Guanajuato (MX); Yareth Carolina HERNANDEZ GONZALEZ, Guanajuato (MX)

(21) Appl. No.: 19/556,342

(22) Filed: Mar. 4, 2026

Related U.S. Application Data
(60) Provisional application No. 63/796,717, filed on Apr. 29, 2025.

(51) Int. Cl. B05B 1/02; F16K 17/02; F16K 24/04

(52) U.S. Cl. CPC B05B 1/02; F16K 17/02; F16K 24/04

(57) ABSTRACT

A nozzle assembly for a pressure relief valve of a compressor includes a base portion releasably coupled to a valve body of the pressure relief valve and extending about an outlet port of the pressure relief valve, an outlet portion extending axially away from the base portion, a discharge passage defined between the base portion and the outlet portion, and a discharge opening formed within the outlet portion and fluidly coupled to the discharge passage. The discharge opening discharges a refrigerant from the compressor in response to a refrigerant pressure of the refrigerant meeting or exceeding a predetermined refrigerant pressure threshold. The discharge opening generates a predetermined spray pattern having at least one of a predetermined spray angle, a predetermined spray distance, and a predetermined droplet size.

### CROSS-REFERENCE TO RELATED APPLICATION

This application claim the benefit of U.S. Provisional Application No. 63/796,717 filed Apr. 29, 2025, titled “COMPRESSOR PRV NOZZLE”, the entire disclosure of which is incorporated by reference herein.

### TECHNICAL FIELD

The present disclosure relates to compressors for vehicle systems, and more particularly, to nozzles and other similar attachment mechanisms for pressure relief valves.

### BACKGROUND

Automotive compressors are commonly equipped with pressure relief valves that are configured to open when a refrigerant pressure within the compressor exceeds a predetermined threshold. In operation, the pressure relief valve may prevent damage to the compressor and associated refrigerant lines by venting refrigerant and/or oil to the surrounding automotive engine compartment. In traditional compressors, the pressure relief valve is typically mounted with a simple cap or cover that may define an outlet opening, such that, when the pressure relief valve opens, refrigerant is expelled through the outlet opening and into the engine compartment.

Although conventional pressure relief valve caps may allow refrigerant to escape the compressor, these caps provide little to no control over the trajectory, spray geometry, or droplet size of the discharged refrigerant. As a result, refrigerant may often exit the outlet opening defined by the cap as an uncontrolled jet or mist that may contact nearby engine components. In some scenarios, the uncontrolled discharge of refrigerant may impinge on high-temperature components within the engine (e.g., exhaust manifolds, catalytic converters, turbochargers, etc.), leading to thermal shock, surface cracking, and/or other similarly undesirable reactions. Furthermore, the lack of spray control provided by traditional caps may also cause sensitive engine components to be contaminated by discharged refrigerant.

Accordingly, a need exists for a nozzle assembly that may be implemented on a pressure relief valve of an automotive compressor to allow for the direction and shape of discharged refrigerant to be controlled within the engine compartment.

### SUMMARY

In an embodiment of the present disclosure, a nozzle assembly for a pressure relief valve of a compressor is disclosed. The nozzle assembly includes a base portion releasably coupled to a valve body of the pressure relief valve and extending about an outlet port of the pressure relief valve, an outlet portion extending axially away from the base portion, a discharge passage defined between the base portion and the outlet portion, and a discharge opening formed within the outlet portion and fluidly coupled to the discharge passage. The discharge opening discharges a refrigerant from the compressor in response to a refrigerant pressure of the refrigerant meeting or exceeding a predetermined refrigerant pressure threshold. The discharge opening generates a predetermined spray pattern having at least one of a predetermined spray angle, a predetermined spray distance, and a predetermined droplet size.

In another embodiment of the present disclosure, an engine assembly is disclosed. The engine assembly includes an engine block, a compressor mounted to the engine block and configured to circulate a refrigerant through a vehicle system of the engine assembly, a pressure relief valve mounted within a housing the compressor, the pressure relief valve including an outlet port in fluid communication with the compressor and a nozzle assembly removably coupled to the outlet port. The nozzle assembly includes a base portion releasably coupled to a valve body of the pressure relief valve, an outlet portion extending axially away from the base portion, a discharge passage defined between the base portion and the outlet portion, and a discharge opening formed within the outlet portion and fluidly coupled to the discharge passage, the discharge opening configured to discharge a refrigerant from the compressor when a refrigerant pressure of the refrigerant meets or exceeds a predetermined refrigerant pressure threshold. The discharge opening is further configured to generate a predetermined spray pattern having at least one of a predetermined spray angle, a predetermined spray distance, and a predetermined droplet size.

In yet another embodiment, a method of controlling a discharge of a refrigerant from a pressure relief valve of a compressor is disclosed. The method includes selecting a nozzle assembly having a predetermined geometric profile configured to generate a predetermined spray pattern; securing a base portion of the nozzle assembly to a valve body of the pressure relief valve, such that an outlet port of the pressure relief valve is in fluid communication with a discharge passage defined within the nozzle assembly; and operating the compressor, such that, when a refrigerant pressure of the refrigerant meets or exceeds a predetermined pressure threshold, the refrigerant is discharged from the nozzle assembly in the predetermined spray pattern.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a vehicle engine block, according to one or more embodiments shown and described herein;

FIG. 2 is a perspective view of a pressure relief valve of a compressor of the engine block of FIG. 1, according to one or more embodiments shown and described herein;

FIG. 3A is a side-view of a nozzle assembly of the pressure relief valve of FIG. 2, according to one or more embodiments shown and described herein;

FIG. 3B is a front-side view of the nozzle assembly of FIG. 3A, according to one or more embodiments shown and described herein;

FIG. 4A is a perspective view of another embodiment of a nozzle assembly of the pressure relief valve of FIG. 2, according to one or more embodiments shown and described herein;

FIG. 4B is a front-side view of a spray pattern of the nozzle assembly of FIG. 4A, according to one or more embodiments shown and described herein;

FIG. 5A is a perspective view of another embodiment of a nozzle assembly of the pressure relief valve of FIG. 2, according to one or more embodiments shown and described herein;

FIG. 5B is a front-side view of a spray pattern of the nozzle assembly of FIG. 5A, according to one or more embodiments shown and described herein;

FIG. 6A is a perspective view of another embodiment of a nozzle assembly of the pressure relief valve of FIG. 2, according to one or more embodiments shown and described herein;

FIG. 6B is a front-side view of a spray pattern of the nozzle assembly of FIG. 6A, according to one or more embodiments shown and described herein;

FIG. 7 is a front-side view of a spray pattern of another embodiment of a nozzle assembly of the pressure relief valve of FIG. 2, according to one or more embodiments shown and described herein;

FIG. 8 is a front-side view of a spray pattern of another embodiment of a nozzle assembly of the pressure relief valve of FIG. 2, according to one or more embodiments shown and described herein; and

FIG. 9 is an illustrative flow diagram of a method of controlling discharge of a fluid from a pressure relief valve of a compressor of an engine block, according to one or more embodiments shown and described herein.

Other features and advantages of the present disclosure will be understood from the following embodiments described in detail herein and with reference to the accompanying drawings, in which like reference numerals represent the same or similar components.

### DETAILED DESCRIPTION

In the embodiments described herein a nozzle assembly for a pressure relief valve of a compressor includes a base portion releasably coupled to a valve body of the pressure relief valve, such that the base portion extends about an outlet port of the pressure relief valve, an outlet portion extending axially away from the base portion, a discharge passage defined between the base portion and the outlet portion, and a discharge opening formed within the outlet portion and fluidly coupled to the discharge passage, the discharge opening configured to discharge a refrigerant from the compressor when a refrigerant pressure of the refrigerant meets or exceeds a predetermined refrigerant pressure threshold. The discharge opening is further configured to generate a predetermined spray pattern having at least one of a predetermined spray angle, a predetermined spray distance, and a predetermined droplet size. By controlling the spray angle, spray distance, and/or droplet size of the refrigerant discharged from the compressor, the disclosed nozzle assembly may be capable of ensuring that refrigerant directed away from high-temperature components and other similarly sensitive components positioned within an engine block of a vehicle.

It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

As used herein, the term “refrigerant” may generally include working fluids that may circulate within a vehicle and are compressible, vaporizable, and/or condensable without departing from the scope of the present disclosure.

As described hereinabove, traditional automotive compressors often utilize caps that may define an outlet opening configured to allow refrigerant and/or oil to escape the compressor. However, these conventional caps provide little to no control over the trajectory, spray geometry, or droplet size of the discharged refrigerant and/or oil. As a result, refrigerant may often exit the outlet opening defined by the cap as an uncontrolled jet or mist that may contact nearby engine components.

In many instances, the uncontrolled discharge of refrigerant and/or oil within the engine bay may lead to a number of safety and reliability concerns. For example, contact between the refrigerant and high-temperature engine components positioned within the engine bay may lead to thermal shock, surface cracking, and other undesirable reactions. Furthermore, in some scenarios, the refrigerant may be discharged such that the refrigerant inadvertently interacts with sensitive engine components that may be contaminated or otherwise inhibited by the refrigerant. The uncontrolled discharge of refrigerant and/or oil may also lead to issues with regulatory requirements, as many manufacturers may specify that discharged refrigerant be directed away from accessory drive components, electrical devices, and other high-voltage hardware positioned in the engine bay.

The disclosed nozzle assembly aims to address these shortcomings by providing a nozzle that may be retrofit onto a pressure relief valve and used to direct and/or shape the discharge of refrigerant from the compressor within the engine bay. The nozzle assembly described herein may aid manufacturers in meeting safety and regulatory requirements, while also minimizing the risk of refrigerant contacting hot and/or electrically sensitive components within the engine.

Embodiments of nozzle assemblies and methods of controlling discharge of a fluid from a pressure relief valve in a compressor will now be described in additional detail herein. The following will now describe these nozzle assemblies in detail with reference to the drawings and where like numbers refer to like structures.

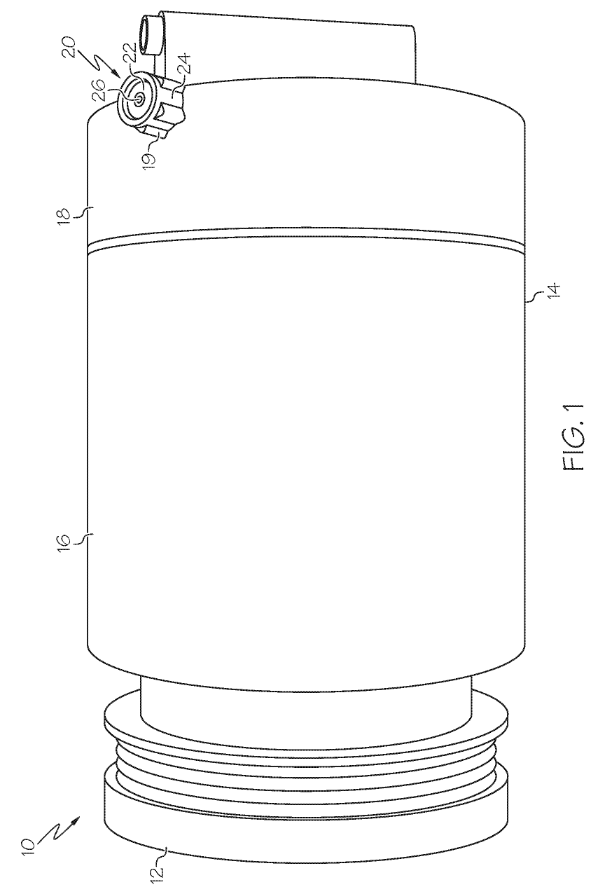

Referring now to FIG. 1, a vehicle engine assembly 10 is depicted. The vehicle engine assembly 10 may include an engine 12, such as an internal combustion engine, and a compressor 14 mounted within an engine block 16 of the engine 12. In these embodiments, the compressor 14 may be driven by the engine 12 via a front end accessory drive (FEAD) system (not depicted). In operation, the compressor 14 may be configured to circulate refrigerant through a vehicle circuit (e.g., air conditioning circuit, etc.) by compressing low-pressure refrigerant from an evaporator (not depicted) and discharging high-pressure fluid refrigerant.

As further depicted in FIG. 1, the compressor 14 may include a pressure relief valve 20. The pressure relief valve 20 may be positioned within a housing 18 of the compressor 14, such that the pressure relief valve 20 may be accessible from an exterior of the compressor 14. In these embodiments, the pressure relief valve 20 may be communicatively and/or fluidly coupled to an internal passage (not depicted) of the compressor 14. Accordingly, in the embodiments described herein, the pressure relief valve 20 may be actuated between an open position and a closed position based on a refrigerant pressure of a refrigerant flowing within the internal passage of the compressor 14.

For example, when the refrigerant pressure of the refrigerant within the compressor 14 meets and/or exceeds a predetermined refrigerant pressure threshold, the force of the refrigerant acting on the pressure relief valve 20 may cause the pressure relief valve 20 to move from the closed position to the open position. Once actuated to the open position, refrigerant within the compressor may be discharged via an outlet port 22 formed in the pressure relief valve 20, such that the pressure relief valve may provide a fluid path from the compressor 14 to the engine block 16. Furthermore, the pressure relief valve 20 may be situated within the housing 18 of the compressor 14 such that the outlet port 22 projects laterally outward from the housing 18 of the compressor 14 and toward the surrounding engine block 16, thereby allowing refrigerant from the compressor 14 to be discharged within the engine block 16 when the pressure relief valve 20 is moved to the open position.

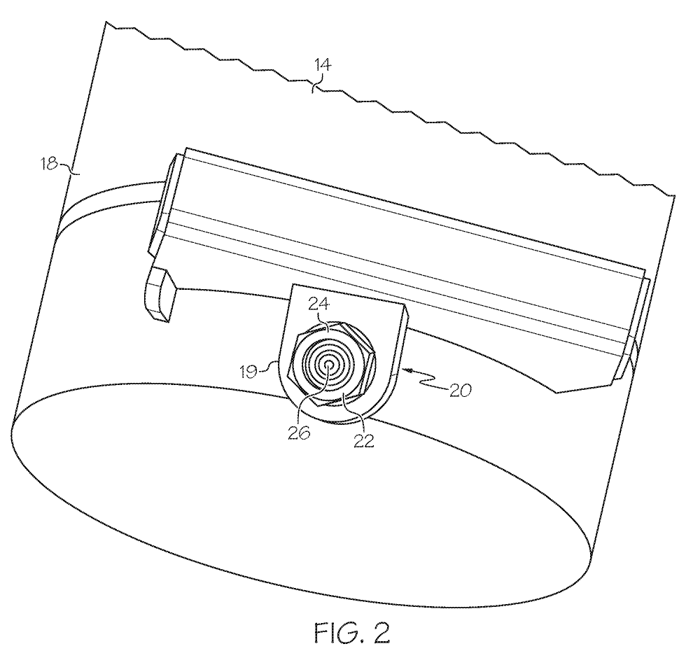

Referring now to FIGS. 1 and 2, the pressure relief valve 20 of the compressor 14 is depicted in additional detail. For example, in these embodiments, the housing 18 of the compressor 14 may further define a valve port 19 in which the pressure relief valve 20 may be situated. The valve port 19 may further act to fluidly couple the outlet port 22 of the pressure relief valve 20 to the internal passage of the compressor 14, such that refrigerant contained within the compressor 14 may be discharged via the pressure relief valve 20 when the pressure relief valve 20 is in the open position.

More particularly, the pressure relief valve 20 may further include a valve body 24, which may be coupled to the valve port 19 (e.g., via threaded engagement, press-fit engagement, etc.) to secure the pressure relief valve 20 within the housing 18 of the compressor 14. In these embodiments, the pressure relief valve 20 may also include a valve element 26, which may be disposed within the valve body 24 and positioned between the outlet port 22 and the internal passage of the compressor 14. The valve element 26 may be actuatable between the open position and the closed position based on the refrigerant pressure of the refrigerant within the compressor 14, as described hereinabove. For example, under normal operating pressure, the valve element 26 may be positioned within the valve body 24 of the pressure relief valve 20 such that the valve element 26 obstructs (e.g., seals, etc.) the outlet port 22 and prevents refrigerant from being discharged from the pressure relief valve 20. When the refrigerant pressure exceeds the predetermined refrigerant pressure threshold, the valve element 26 may be actuated away from the outlet port 22, such that the pressure relief valve 20 is moved to open position and refrigerant is discharged from the compressor 14 and into the engine block 16.

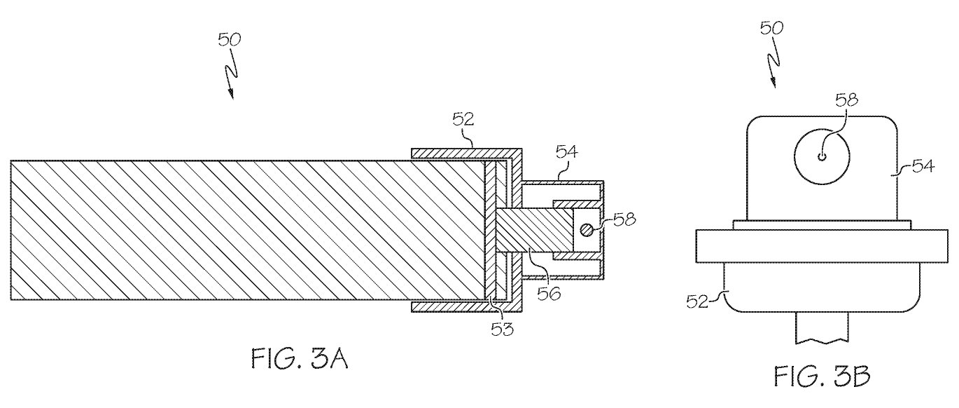

Referring now to FIGS. 1 – 3B, the pressure relief valve 20 may be further configured to receive a nozzle assembly 50. For example, as depicted most clearly in FIGS. 3A and 3B, the nozzle assembly 50 may be coupled to the valve body 24 such that the nozzle assembly 50 may define a discharge passage configured to control a direction, angle, distance, and/or droplet size of the refrigerant discharged from the compressor 14, as will be described in additional detail herein.

Referring still to FIGS. 1 – 3B, the nozzle assembly 50 may include a base portion 52 that may be releasably coupled to the valve body 24 of the pressure relief valve 20, such that the base portion 52 of the nozzle assembly 50 may be in fluid communication with the outlet port 22 of the pressure relief valve 20. For example, the base portion 52 of the nozzle assembly 50 may be secured to the valve body 24 of the pressure relief valve 20 via a threaded coupling, a snap-fit engagement, an interference fit engagement, or any other similar releasable coupling that enables the nozzle assembly 50 to be installed and removed from the pressure relief valve 20 without altering the pressure relief valve 20 itself. It should be appreciated that, in these embodiments, the releasably coupling the nozzle assembly 50 to the pressure relief valve 20 may allow the nozzle assembly 50 to be retrofit on the pressure relief valve 20, thereby avoiding the need to redesign and/or replace an existing pressure relief valve in order to employ the disclosed nozzle assembly 50.

In these embodiments, the nozzle assembly 50 may further include a seal 53, such as an O-ring, gasket, elastomer lip, or other similar seal disposed between the base portion 52 of the nozzle assembly 50 and the outlet port 22 of the pressure relief valve 20. It should be appreciated that, in these embodiments, the seal 53 may prevent leakage of refrigerant at the interface between the pressure relief valve 20 and the nozzle assembly 50.

As further illustrated in FIGS. 1 – 3B, the nozzle assembly 50 may also include an outlet portion 54 extending axially (e.g., in the + x-direction as depicted in the coordinate axes of FIGS. 3A and 3B) away from the base portion 52. In these embodiments, a discharge passage 56 may be defined through the outlet portion 54 (e.g., extending from the base portion 52 and through the outlet portion 54) and include internal geometry configured to control the discharge of refrigerant from the pressure relief valve 20. For example, the internal geometry of the outlet portion 54 of the nozzle assembly 50 may be configured to control at least one of a direction, cone angle, spray distance, and/or droplet size of the refrigerant expelled from the pressure relief valve 20, as will be described in additional detail herein.

In the embodiments described herein, the outlet portion 54 may be integrally formed with the base portion 52 of the nozzle assembly 50, such that the nozzle assembly 50 is formed as a single, monolithic structure. However, in other embodiments, the outlet portion 54 may be removably coupled with the base portion 52 of the nozzle assembly 50. For example, the outlet portion 54 may be a modular outlet portion, such that interchangeable outlet portions may be employed on a common base portion in order to provide control over various characteristics of the discharged refrigerant, as described hereinabove.

To this extent, it should be appreciated that the nozzle assembly 50 described herein may generally include the disclosed base portion 52, outlet portion 54, and discharge passage 56. However, various nozzle assemblies having different geometry (e.g., internal or external) may be employed on the pressure relief valve 20 in order to provide control over the various characteristics of the discharged refrigerant described herein. For example, a technician may unscrew, unclip, or otherwise release a first nozzle assembly having a first geometric profile from the pressure relief valve 20 and replace the first nozzle assembly with a second nozzle assembly having a second geometric profile different from the first geometric profile. It should be understood that the modularity of the disclosed nozzle assembly 50 may allow a manufacturer to specify various spray geometries (e.g., geometric profiles) for various engine blocks while utilizing a common pressure relief valve 20 and/or compressor 14.

Referring still to FIGS. 1 – 3B, the outlet portion 54 of the nozzle assembly 50 may further define a discharge port 58 through which refrigerant from the compressor 14 may be discharged when the pressure relief valve 20 is moved to the open position. In these embodiments, the discharge port 58 may be fluidly coupled to the discharge passage 56 (e.g., defined through the outlet portion 54), such that refrigerant passing through the discharge passage 56 may be expelled into the engine block 16 via the discharge port 58. In these embodiments, the discharge port 58 may be configured to define a primary discharge pattern of the refrigerant expelled from the nozzle assembly 50. For example, the discharge port 568 may include a discharge port diameter, a discharge port length, and/or a discharge port angle that may be impact a cone angle and/or a spray distance of the refrigerant expelled from the nozzle assembly 50, as will be described in additional detail herein.

In the embodiments described, it should be understood that the nozzle assembly 50 may be formed of various materials configured to withstand high thermal and pressure loads during operation of the engine 12 and/or compressor 14. For example, the nozzle assembly 50 described herein may be formed of high-temperature thermoplastics (PEEK, PPS, nylon, etc.), aluminum, stainless steel, or any other similar material without departing from the scope of the present disclosure. Furthermore, in some embodiments, the nozzle assembly 50 may also include various material coatings, such as fluoropolymer or other similar polymers, without departing from the scope of the present disclosure.

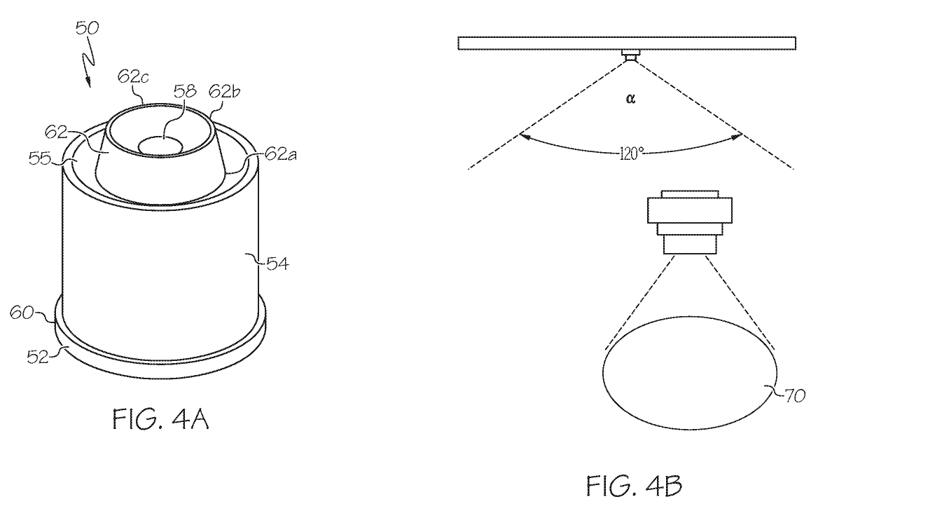

Turning now to FIGS. 1 – 8, embodiments of nozzle assemblies will now be described in additional detail herein. The nozzle assemblies depicted in FIGS. 4A – 8 may be similar in structure to the nozzle assembly 50 depicted in FIGS. 3A – 3B, such that like reference numerals may be used to refer to like structure where applicable.

Referring now to FIGS. 1, 2, and 4A-4B, a nozzle assembly 50 configured to deploy a full cone shaped refrigerant discharge spray is depicted. In these embodiments, the base portion 52 of the nozzle assembly 50 may include a lip 60 configured to interface with the valve body 24 of the pressure relief valve 20. For example, in these embodiments, the lip 60 may include an internal thread which may be configured to engage a complementary external thread formed about an exterior surface of the valve body 24. In other embodiments, the lip 60 may be configured to form a snap-fit, or other similar interference fit, with the valve body 24 of the pressure relief valve 20.

As further illustrated in FIGS. 4A and 4B, the outlet portion 54 may further include a protrusion 62, such as a conical protrusion, which may extend in an axial direction (e.g., in the +/- y-direction as depicted in FIGS. 4A and 4B) away from the outlet portion 54. In these embodiments, the protrusion 62 may be a tapered protrusion, such that a distal portion 62a of the protrusion 62 includes a distal portion diameter which is greater than a proximal portion diameter of a proximal portion 62b of the outlet portion 54. It should be appreciated that, in these embodiments, the tapered profile of the protrusion 62 may aid in controlling a refrigerant velocity of the refrigerant passing through the nozzle assembly 50, which may impact the spray pattern of the refrigerant discharge, as will be described in additional detail herein.

Referring still to FIGS. 4A and 4B, the distal portion diameter of the distal portion 62a of the protrusion 62 may also be smaller than an outlet portion diameter of the outlet portion 54. Accordingly, in these embodiments, the outlet portion 54 may further define a shoulder 55 which extends inwardly (e.g., in the +/- x-direction as depicted in the coordinate axes of FIGS. 4A and 4B) to engage with the distal portion 62a of the protrusion 62. In these embodiments, the shoulder 55 may also be formed as a tapered shoulder, such that the shoulder 55 defines a convex region extending about the distal portion 62a of the protrusion 62. As noted hereinabove, the geometry of the shoulder 55 (e.g., the convex region) may further impact the spray pattern of the refrigerant discharge, as will be described in additional detail herein.

Referring still to FIGS. 4A and 4B, the proximal portion 62b of the protrusion 62 may further define the discharge port 58 of the nozzle assembly 50, which may be shaped as a circular discharge opening. In these embodiments, the discharge port 58 may be offset from a proximal end face 62c of the proximal portion 62b of the protrusion 62, such that the discharge port 58 is seated inwardly (e.g., in the – y-direction as depicted in the coordinate axes of FIGS. 4A and 4B) relative the proximal end face 62c of the protrusion 62. It should be appreciated that, in these embodiments, the shape of the discharge port 58, together with the tapered profile of the protrusion 62, may produce a full cone spray pattern 70 when refrigerant is discharged from the nozzle assembly 50.

In the embodiments described herein, and as depicted most clearly in FIG. 4B, the refrigerant discharged from the nozzle assembly 50 may form a generally uniform conical volume of droplets that extend in the full cone spray pattern 70 a predetermined distance from the discharge port 58. It should be appreciated that, the spray angle α and the predetermined distance which the full cone spray pattern 70 is discharged may be adjusted by altering a length-to-diameter ratio of the protrusion 62 and/or the taper of the protrusion 62 and/or the discharge port 58. For example, a longer, narrower protrusion 62 may generate a smaller spray angle α, while a wider, shorter protrusion 62 may generate a larger spray angle α. Furthermore, a droplet size of the discharge that forms the full cone spray pattern 70 may also be manipulated by adjusting a discharge port diameter of the discharge port 58.

In the embodiments described herein, it should be further appreciated that the nozzle assembly 50 depicted in FIGS. 4A and 4B may be formed as a single molded and/or machined component or as a multi-piece assembly in which the protrusion 62 is replaceable within the outlet portion 54 in order to adjust the spray angle and/or droplet size of the full cone spray pattern 70. Furthermore, it should be understood that the full cone spray pattern 70 enabled by the nozzle assembly of FIGS. 4A and 4B may allow a manufacturer to direct a predictable, solid spray pattern of refrigerant away from high-temperature components positioned within the engine block 16 while also controlling a distance which the refrigerant travels before dispersing.

Referring now to FIGS. 1, 2 and 5A-5B, another embodiment of a nozzle assembly 50 is disclosed. In these embodiments, the nozzle assembly 50 may be configured to deploy a hollow cone shaped refrigerant discharge spray pattern, as will be described in additional detail herein.

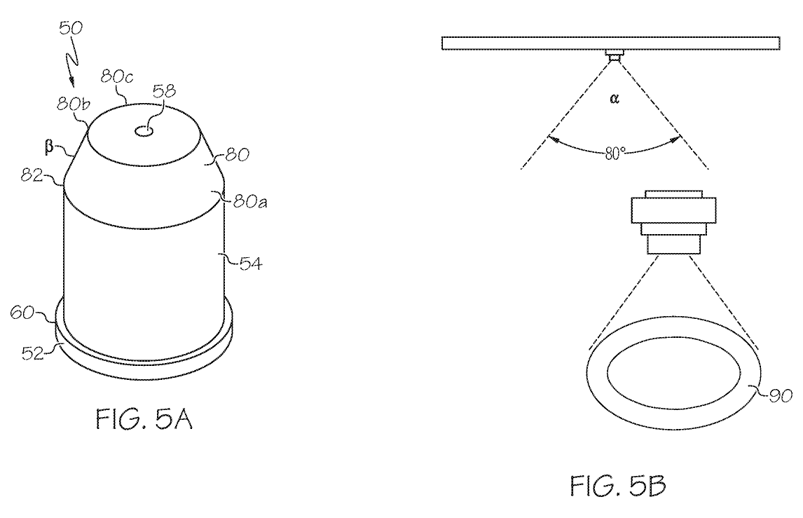

As depicted most clearly in FIGS. 5A and 5B, in these embodiments, the base portion 52 of the nozzle assembly 50 may include a lip 60 configured to interface with the valve body 24 of the pressure relief valve 20. For example, in these embodiments, the lip 60 may include an internal thread which may be configured to engage a complementary external thread formed about an exterior surface of the valve body 24. In other embodiments, the lip 60 may be configured to form a snap-fit, or other similar interference fit, with the valve body 24 of the pressure relief valve 20.

Furthermore, the outlet portion 54 of the nozzle assembly 50 may further include an extension member 80, which may extend axially away from the outlet portion 54 (e.g., in the + y-direction as depicted in the coordinate axes of FIGS. 5A and 5B). In these embodiments, the extension member 80 may be conically shaped, such that the extension member 80 tapers a long a length of the extension member 80 (e.g., decreases in diameter as the extension member 80 extends axially away from the outlet portion 54).

In these embodiments, the extension member 80 may extend between a distal extension member end 80a formed adjacent the outlet portion 54 and a proximal extension member end 80b positioned opposite the distal extension member end 80a (e.g., extending away from the outlet portion 54). As depicted most clearly in FIG. 5A, the distal extension member end 80a may have a diameter that is equal to an outlet portion diameter of the outlet portion 54, such that the location at which the extension member 80 interfaces with the outlet portion 54 may define a transition region 82 that aids in generating the hollow cone shaped spray pattern illustrated in FIG. 5B, as will be described in additional detail herein.

Referring still to FIGS. 5A and 5B, the proximal extension member end 80b may further define a proximal extension member end face 80c, and the discharge port 58 of the nozzle assembly 50 may be formed in the proximal extension member end face 80c, such that the discharge port 58 and the proximal extension member end face 80c are coplanar. In the embodiments described herein, and as depicted most clearly in FIG. 5B, the refrigerant discharged from the nozzle assembly 50 may form a generally uniform conical volume of droplets that extend in a hollow cone spray pattern 90 (e.g., ring-shaped spray pattern) a predetermined distance from the discharge port 58. It should be appreciated that, the spray angle α and the predetermined distance which the hollow cone spray pattern 90 is discharged may be adjusted by altering a taper angle β of the transition region 82 and/or the discharge opening diameter of the discharge port 58. For example, a smaller discharge opening diameter or sharper taper angle β may yield a narrower hollow cone that is discharged a greater predetermined distance, while a larger discharge opening diameter or softer taper angle β may yield a wider, shorter hollow cone spray pattern 90.

In the embodiments described herein, it should be further appreciated that the nozzle assembly 50 depicted in FIGS. 5A and 5B may be formed as a single molded and/or machined component or as a multi-piece assembly in which the extension member 80 is replaceable within the outlet portion 54 in order to adjust the spray angle and/or droplet size of the hollow cone spray pattern 90. Furthermore, it should be understood that the hollow cone spray pattern 90 enabled by the nozzle assembly of FIGS. 5A and 5B may allow a manufacturer to direct a project a spray pattern of refrigerant around, rather than directly at, certain components positioned within the engine block 16.

Referring now to FIGS. 1, 2 and 6A-6B, another embodiment of a nozzle assembly 50 is disclosed. In these embodiments, the nozzle assembly 50 may be configured to deploy a flat, or fan, shaped refrigerant discharge spray pattern, as will be described in additional detail herein.

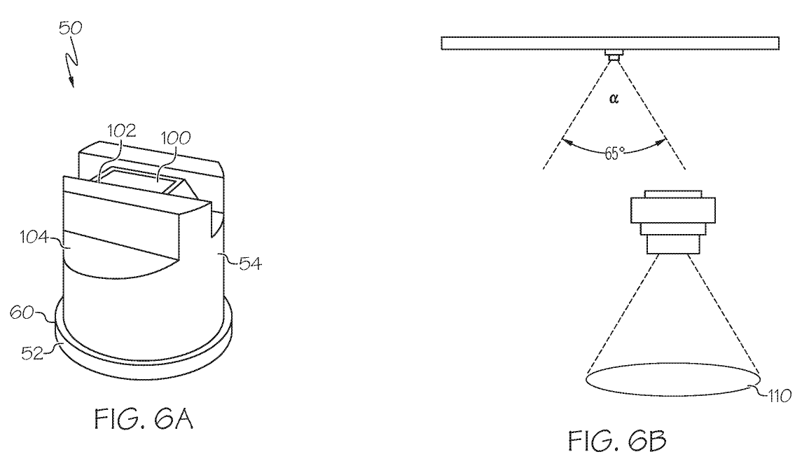

As depicted most clearly in FIGS. 6A and 6B, in these embodiments, the base portion 52 of the nozzle assembly 50 may include a lip 60 configured to interface with the valve body 24 of the pressure relief valve 20. For example, in these embodiments, the lip 60 may include an internal thread which may be configured to engage a complementary external thread formed about an exterior surface of the valve body 24. In other embodiments, the lip 60 may be configured to form a snap-fit, or other similar interference fit, with the valve body 24 of the pressure relief valve 20.

Furthermore, as illustrated most clearly in FIG. 6A, the outlet portion 54 of the nozzle assembly 50 may further define a discharge slot 100, such that a slot height and a slot width of the discharge slot 100 determine a sheet thickness and a lateral spread of the flat discharge spray pattern 110 (e.g., as shown in FIG. 6B). In these embodiments, the discharge slot 100 may further define a plurality of slot edges 102, which may be provided with various machining finishes configured to impact a predetermined distance at which the flat discharge spray pattern 110 is discharged from the nozzle assembly 50. For example, in some embodiments, the plurality of slot edges 102 may include a chamfer, with the chamfered edges being configured to promote the refrigerant discharged from the nozzle assembly 50 to be dispersed into droplets which increase the predetermined distance of the refrigerant discharge from the nozzle assembly 50. In other embodiments, the plurality of slot edges 102 may be formed as rounded edges, which may promote a softer discharge which decreases the predetermined distance of the flat discharge spray pattern 110.

Furthermore, the outlet portion 54 of the nozzle assembly 50 may include a plurality of relief portions 104, which may be formed as cut-away side regions positioned adjacent the discharge slot 100. By removing material adjacent to the discharge slot 100, the outlet portion 54 may diverge outwardly, thereby allowing refrigerant to be discharged from the nozzle assembly 50 in the flat discharge spray pattern 110 upon exiting the discharge slot 100. Furthermore, the plurality of relief portions 104 may also reduce obstruction along the plurality of slot edges 102 of the discharge slot 100, such that the refrigerant discharge may expand symmetrically upon exiting the discharge slot 100 (e.g., as opposed to striking the outlet portion 54 of the nozzle assembly 50).

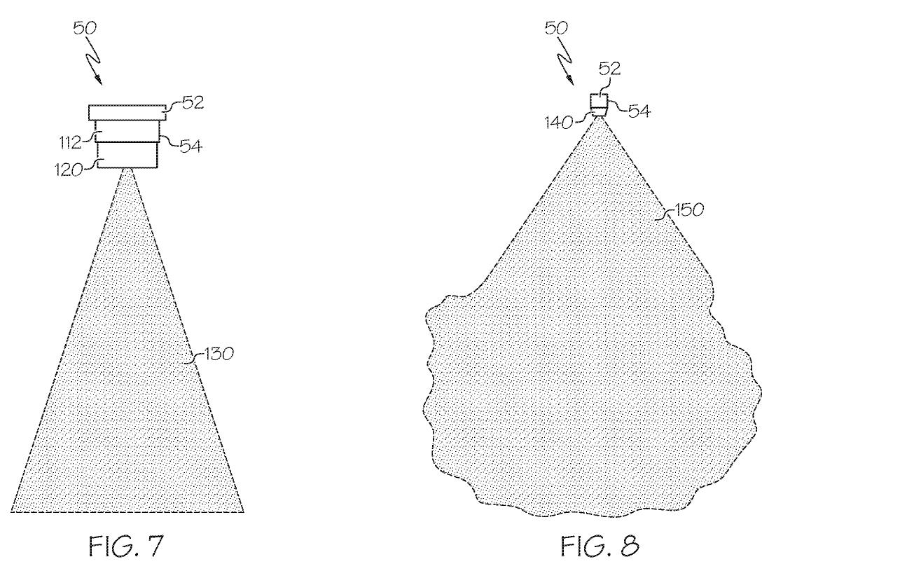

Turning now to FIG. 7, another embodiment of a nozzle assembly 50 is disclosed. In these embodiments, the outlet portion 54 of the nozzle assembly 50 may further define a discharge tip 120 that may be configured to generate an atomized spray pattern 130, as will be described in additional detail herein.

Referring still to FIG. 7, the outlet portion 54 of the nozzle assembly 50 may be further configured to introduce a secondary fluid (e.g., air, etc.) into the outlet portion 54 in order to break the refrigerant discharged from the discharge tip 120 into smaller droplets (e.g., to atomize the refrigerant). Accordingly, in these embodiments, the outlet portion 54 may further include a plurality of inlets 112 in fluid communication with the discharge passage define by the outlet portion 54 of the nozzle assembly 50. In operation, when the pressure relief valve 20 is actuated to the open position, the nozzle assembly 50 may further draw in air through the plurality of inlets 112, such that the air mixes with the refrigerant discharge and causes the refrigerant discharge to shear into fine (e.g., atomized) droplets.

Turning now to FIG. 8, another embodiment of a nozzle assembly 50 is disclosed. In these embodiments, the outlet portion 54 of the nozzle assembly 50 may further include the discharge tip 120, with the discharge tip 120 being configured to generate a fine spray pattern 150 without relying on an external air source.

For example, in these embodiments, the outlet portion 54 may further include a throat 140, or restriction section, which may be positioned upstream of the discharge tip 120. It should be appreciated that, as depicted in FIG. 8, reducing the cross-sectional area of the outlet portion 54 at the throat 140 may further increase the velocity of the refrigerant as the refrigerant is discharged from the discharge tip 120, such that the refrigerant may shear and at least partially vaporize as the refrigerant is discharged.

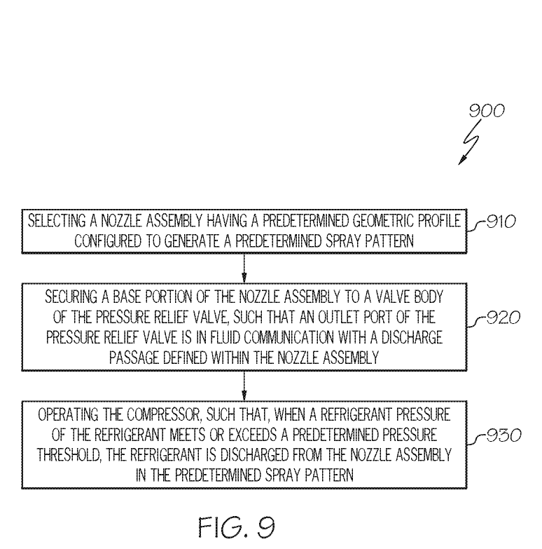

Turning now to FIG. 9, an illustrative flow diagram of a method 900 of controlling a discharge of a refrigerant from a pressure relief valve of a compressor is depicted. In these embodiments, the method may initially involve selecting a nozzle assembly having a predetermined geometric profile configured to generate a predetermined spray pattern, as is depicted at block 910.

Once a manufacturer or user has selected a nozzle assembly having a desired geometric profile and spray pattern, the method may proceed to block 920, which may include securing a base portion of the nozzle assembly to a valve body of the pressure relief valve, such that an outlet port of the pressure relief valve is in fluid communication with a discharge passage defined within the nozzle assembly. With the nozzle assembly coupled to the pressure relief, the method may proceed to block 930, which may include operating the compressor, such that, when a refrigerant pressure of the refrigerant meets or exceeds a predetermined pressure threshold, the refrigerant is discharged from the nozzle assembly in the predetermined spray pattern.

In view of the foregoing, it should be appreciated that the embodiments described herein relate to a nozzle assemblies configured to direct discharge of refrigerant from a compressor within an engine block. While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A nozzle assembly for a pressure relief valve of a compressor, the nozzle assembly comprising:
a base portion releasably coupled to a valve body of the pressure relief valve, such that the base portion extends about an outlet port of the pressure relief valve;
an outlet portion extending axially away from the base portion;
a discharge passage defined between the base portion and the outlet portion; and
a discharge opening formed within the outlet portion and fluidly coupled to the discharge passage, the discharge opening configured to discharge a refrigerant from the compressor in response to a refrigerant pressure of the refrigerant meeting or exceeding a predetermined refrigerant pressure threshold;
wherein the discharge opening is further configured to generate a predetermined spray pattern having at least one of a predetermined spray angle, a predetermined spray distance, and a predetermined droplet size.

2. The nozzle assembly of claim 1, wherein the outlet portion is integrally formed with the base portion to form a single, monolithic structure.

3. The nozzle assembly of claim 1, wherein the outlet portion is removably coupled to the base portion.

4. The nozzle assembly of claim 1, further comprising a protrusion extending axially away from the outlet portion.

5. The nozzle assembly of claim 4, wherein the protrusion is a tapered protrusion, such that a distal portion of the protrusion has a distal portion diameter that is greater than a proximal portion diameter of a proximal portion of the protrusion.

6. The nozzle assembly of claim 5, wherein the distal portion diameter of the distal portion of the protrusion is smaller than an outlet portion diameter of the outlet portion, and the outlet portion further defines a shoulder extending inwardly to engage the distal portion of the protrusion.

7. The nozzle assembly of claim 6, wherein the shoulder is a tapered shoulder that forms a convex region extending about the distal portion of the protrusion.

8. The nozzle assembly of claim 4, wherein the protrusion is removably coupled to the outlet portion of the nozzle assembly.

9. The nozzle assembly of claim 1, further comprising a conical extension member extending axially away from the outlet portion.

10. The nozzle assembly of claim 9, wherein the conical extension member and the outlet portion of the nozzle assembly define a tapered transition region.

11. The nozzle assembly of claim 10, wherein the discharge opening is formed on a proximal extension member end face of a proximal end of the extension member, such that the discharge opening and the proximal extension member end face are coplanar.

12. The nozzle assembly of claim 1, wherein the discharge opening is formed as a discharge slot that defines a plurality of slot edges.

13. The nozzle assembly of claim 12, wherein the plurality of slot edges are chamfered.

14. The nozzle assembly of claim 12, wherein the plurality of slot edges are rounded.

15. The nozzle assembly of claim 12, wherein the outlet portion further includes a plurality of relief portions positioned adjacent the discharge slot.

16. The nozzle assembly of claim 1, wherein the discharge opening is formed as a discharge tip, and the outlet portion further defines a plurality of inlets in fluid communication with the discharge passage, such that the plurality of inlets are configured to introduce air into the discharge passage.

17. The nozzle assembly of claim 1, wherein the discharge opening is formed as a discharge tip, and the outlet portion further defines a throat positioned upstream of the discharge tip, the throat being configured to reduce a cross-sectional area of the outlet portion adjacent the discharge tip.

18. An engine assembly comprising:
an engine block;
a compressor mounted to the engine block and configured to circulate a refrigerant through a vehicle system of the engine assembly;
a pressure relief valve mounted within a housing the compressor, the pressure relief valve including an outlet port in fluid communication with the compressor; and
a nozzle assembly removably coupled to the outlet port, the nozzle assembly comprising:
a base portion releasably coupled to a valve body of the pressure relief valve;
an outlet portion extending axially away from the base portion;
a discharge passage defined between the base portion and the outlet portion; and
a discharge opening formed within the outlet portion and fluidly coupled to the discharge passage, the discharge opening configured to discharge a refrigerant from the compressor when a refrigerant pressure of the refrigerant meets or exceeds a predetermined refrigerant pressure threshold;
wherein the discharge opening is further configured to generate a predetermined spray pattern having at least one of a predetermined spray angle, a predetermined spray distance, and a predetermined droplet size.

19. The engine assembly of claim 18, wherein the outlet portion is removably coupled to the base portion.

20. A method of controlling a discharge of a refrigerant from a pressure relief valve of a compressor, the method comprising:
selecting a nozzle assembly having a predetermined geometric profile configured to generate a predetermined spray pattern;
securing a base portion of the nozzle assembly to a valve body of the pressure relief valve, such that an outlet port of the pressure relief valve is in fluid communication with a discharge passage defined within the nozzle assembly; and
operating the compressor, such that, when a refrigerant pressure of the refrigerant meets or exceeds a predetermined pressure threshold, the refrigerant is discharged from the nozzle assembly in the predetermined spray pattern.
